(19) United States
(12) Patent Application Publication
(10) Pub. No.: US 2014/0358607 A1
(43) Pub. Date: Dec. 4, 2014

(54) TEAM MEMBER RECOMMENDATION SYSTEM

(71) Applicant: Linkedln Corporation, Mountain View, CA (US)

(72) Inventors: Prachi Gupta, Santa Clara, CA (US); Florina Xhabija, Mountain View, CA (US); Matthew David Shoup, San Jose, CA (US); Yevgeniy Brikman, Menlo Park, CA (US); Alejandro Crosa, Cupertino, CA (US); Roel Ramirez, Hayward, CA (US)

(21) Appl. No.: 13/907,577

(22) Filed: May 31, 2013

(51) Int. Cl. G06Q 10/06

(52) U.S. Cl. CPC G06Q 10/063112
USPC 705/7.14

(57) ABSTRACT

Techniques for discovering and recruiting team members for a team are described. According to various embodiments, a user request to identify one or more potential team members of a team is received, the user request including a user specification of a specific job title Skill mapping information identifying various sample skills associated with various sample job titles is accessed, and one or more specific skills associated with the specific job title is determined based on the skill mapping information. Thereafter, candidate team members of the team are identified from among members of a social network service having one or more of the specific skills.

### TECHNICAL FIELD

The present application relates generally to data processing systems and, in one specific example, to techniques for discovering and recruiting team members for a team.

### BACKGROUND

Throughout various enterprise organizations and businesses, a significant amount of work is accomplished in teams, where various individuals are required to collaborate and work together in order to successfully complete tasks. Accordingly, the success of many projects often depends on the ability to find and recruit team members that have the qualities and skills that match the needs and requirements of the project or team.

### BRIEF DESCRIPTION OF THE DRAWINGS

Some embodiments are illustrated by way of example and not limitation in the figures of the accompanying drawings in which:

FIG. 1 is a block diagram showing the functional components of a social networking service, consistent with some embodiments of the invention;

FIG. 2 is a block diagram of an example system, according to various embodiments;

FIG. 3 is a flowchart illustrating an example method, according to various embodiments;

FIG. 4 illustrates an exemplary portion of a user interface, according to various embodiments;

FIG. 5 illustrates an example of skill mapping information, according to various embodiments;

FIG. 6 illustrates an example of a member profile page, according to various embodiments;

FIG. 7 illustrates an example of member profile data, according to various embodiments;

FIG. 8 illustrates an exemplary portion of a user interface, according to various embodiments;

FIG. 9 is a flowchart illustrating an example method, according to various embodiments;

FIG. 10 is a flowchart illustrating an example method, according to various embodiments;

FIG. 11 illustrates an exemplary portion of a user interface, according to various embodiments;

FIG. 12 is a flowchart illustrating an example method, according to various embodiments;

FIG. 13 is a flowchart illustrating an example method, according to various embodiments;

FIG. 14 illustrates an example of job title keyword information, according to various exemplary embodiments;

FIG. 15 is a flowchart illustrating an example method, according to various embodiments;

FIG. 16 illustrates an exemplary mobile device, according to various exemplary embodiments; and

FIG. 17 is a diagrammatic representation of a machine in the example form of a computer system within which a set of instructions, for causing the machine to perform any one or more of the methodologies discussed herein, may be executed.

### DETAILED DESCRIPTION

Example methods and systems for discovering and recruiting team members for a team are described. In the following description, for purposes of explanation, numerous specific details are set forth in order to provide a thorough understanding of example embodiments. It will be evident, however, to one skilled in the art that the present invention may be practiced without these specific details.

According to various exemplary embodiments, a team member recommendation system is configured to enable people who have ideas to find people who have skills for helping implement the ideas. For example, the team member recommendation system may enable a team leader to discover and recruit potential team members for a team or project. The team member recommendation system may automatically recruit these potential team members, by transmitting targeted notifications to the potential team members that highlight the teams and projects correlated to their skills and interests

According to various embodiments, a user request to identify one or more potential team members of a team is received, the user request including a user specification of a specific job title Skill mapping information identifying various sample skills associated with various sample job titles is accessed, and specific skills associated with the specific job title are determined based on the skill mapping information. Thereafter, candidate team members of the team are identified from among members of a social network service having one or more of the specific skills.

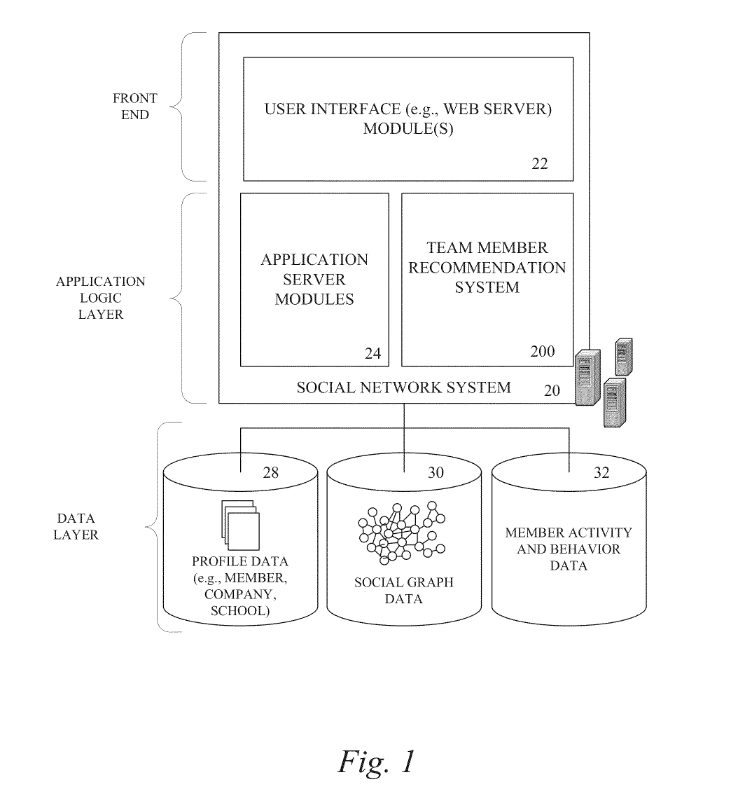

FIG. 1 is a block diagram illustrating various components or functional modules of a social network service such as the social network system 20, consistent with some embodiments. As shown in FIG. 1, the front end consists of a user interface module (e.g., a web server) 22, which receives requests from various client-computing devices, and communicates appropriate responses to the requesting client devices. For example, the user interface module(s) 22 may receive requests in the form of Hypertext Transport Protocol (HTTP) requests, or other web-based, application programming interface (API) requests. The application logic layer includes various application server modules 14, which, in conjunction with the user interface module(s) 22, generates various user interfaces (e.g., web pages) with data retrieved from various data sources in the data layer. With some embodiments, individual application server modules 24 are used to implement the functionality associated with various services and features of the social network service. For instance, the ability of an organization to establish a presence in the social graph of the social network service, including the ability to establish a customized web page on behalf of an organization, and to publish messages or status updates on behalf of an organization, may be services implemented in independent application server modules 24. Similarly, a variety of other applications or services that are made available to members of the social network service will be embodied in their own application server modules 24.

As shown in FIG. 1, the data layer includes several databases, such as a database 28 for storing profile data, including both member profile data as well as profile data for various organizations. Consistent with some embodiments, when a person initially registers to become a member of the social network service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database with reference number 28. Similarly, when a representative of an organization initially registers the organization with the social network service, the representative may be prompted to provide certain information about the organization. This information may be stored, for example, in the database with reference number 28, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph, shown in FIG. 1 with reference number 30.

The social network service may provide a broad range of other applications and services that allow members the opportunity to share and receive information, often customized to the interests of the member. For example, with some embodiments, the social network service may include a photo sharing application that allows members to upload and share photos with other members. With some embodiments, members may be able to self-organize into groups, or interest groups, organized around a subject matter or topic of interest. With some embodiments, the social network service may host various job listings providing details of job openings with various organizations.

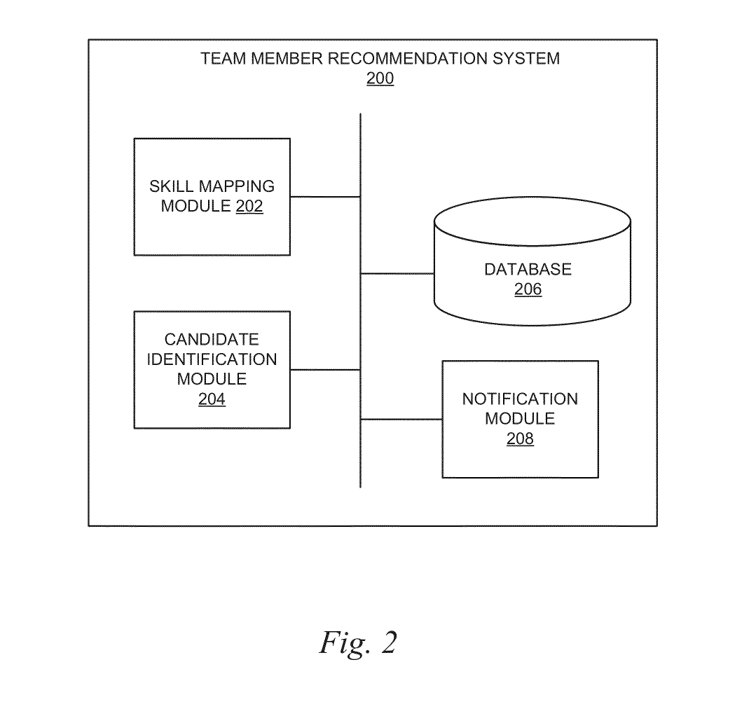

As members interact with the various applications, services and content made available via the social network service, the members' behavior (e.g., content viewed, links or member-interest buttons selected, etc.) may be monitored and information concerning the member's activities and behavior may be stored, for example, as indicated in FIG. 1 by the database with reference number 32. This information may be used to classify the member as being in various categories. For example, if the member performs frequent searches of job listings, thereby exhibiting behavior indicating that the member is a likely job seeker, this information can be used to classify the member as a job seeker. This classification can then be used as a member profile attribute for purposes of enabling others to target the member for receiving messages or status updates. Accordingly, a company that has available job openings can publish a message that is specifically directed to certain members of the social network service who are job seekers, and thus, more likely to be receptive to recruiting efforts. With some embodiments, the social network system 20 includes what is generally referred to herein a team member recommendation system 200. The team member recommendation system 200 is described in more detail below in conjunction with FIG. 2.

Although not shown, with some embodiments, the social network system 20 provides an application programming interface (API) module via which third-party applications can access various services and data provided by the social network service. For example, using an API, a third-party application may provide a user interface and logic that enables an authorized representative of an organization to publish messages from a third-party application to a content hosting platform of the social network service that enables facilitates presentation of activity or content streams maintained and presented by the social network service. Such third-party applications may be browser-based applications, or may be operating system-specific. In particular, some third-party applications may reside and execute on one or more mobile devices (e.g., phone, or tablet computing devices) having a mobile operating system.

Turning now to FIG. 2, a team member recommendation system 200 includes a skill mapping module 202, a candidate identification module 204, a database 206, and a notification module 208. The modules of the team member recommendation system 200 may be implemented on or executed by a single device such as a team builder device, or on separate devices interconnected via a network. The aforementioned team builder device may be, for example, a client machine or application server. The operation of each of the modules of the team member recommendation system 200 is described in more detail below.

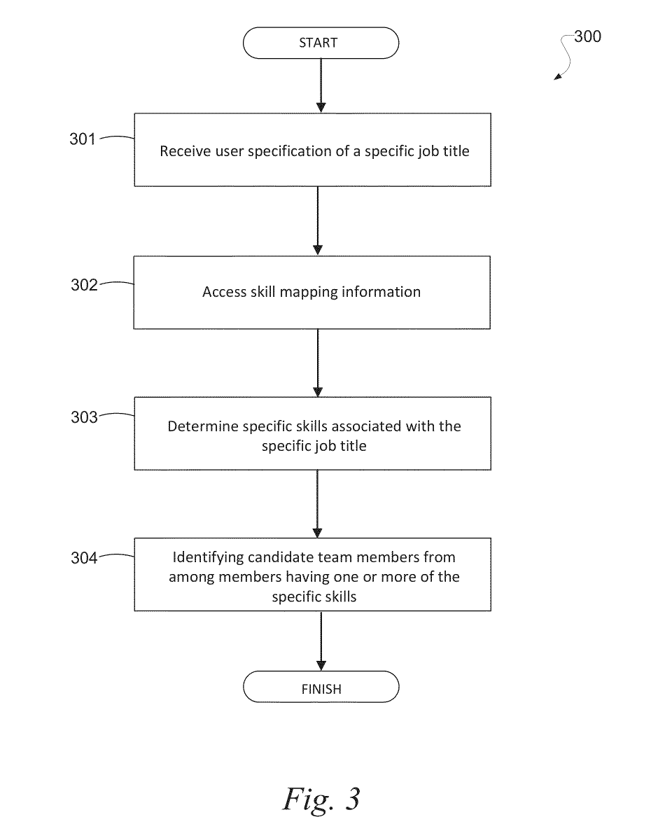

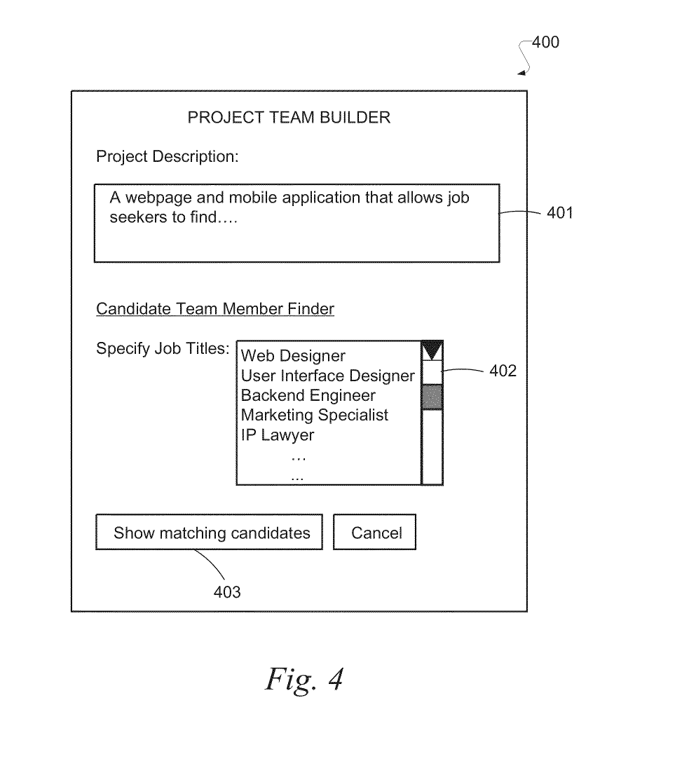

FIG. 3 is a flowchart illustrating an example method 300, according to various exemplary embodiments. The method 300 may be performed at least in part by, for example, the team member recommendation system 200 illustrated in FIG. 2 (or an apparatus having similar modules, such as client machines or application servers). In operation 301, the skill mapping module 202 receives a user request from a user (e.g., a team leader) to find one or more potential team members of a team or project. The user request may include a specification of various job titles of the team members being sought. For example, if the user is a leader of a project or team, it is possible that the user is looking for various team members such as a Web Designer, user interface designer, marketing specialist, IP lawyer, and so on. Accordingly, the skill mapping module 202 may display a user interface to enable the user to specify job titles and to find potential team members for the team or project. FIG. 4 illustrates an exemplary user interface 400 that permits the user (e.g., a team leader) to enter team description information 401 describing a team or project description information 401 describing a project. Although not shown in FIG. 4, the interface 400 may allow the user to enter information identifying team members already assigned to the team or project. The user interface 400 also includes a “candidate key member finder” element 402 that allows the user to specify one or more job titles, by selecting from various predefined job titles (e.g., job titles such as “Web Designer”, “user interface designer”, etc., in a pull-down menu 402). When the user selects the “Show Matching Candidates” user interface element 403 (e.g., a button), the user submits a request to identify potential team members for the team or project, based on the specific job title selected by the user via the “candidate team member finder” element 402. Certain examples herein describe a user selection of a single job title from the pull-down menu 402 in the interest of clarity. However, it is apparent that the aspects of this disclosure are applicable to a user specification of multiple job titles from the pull-down menu 402.

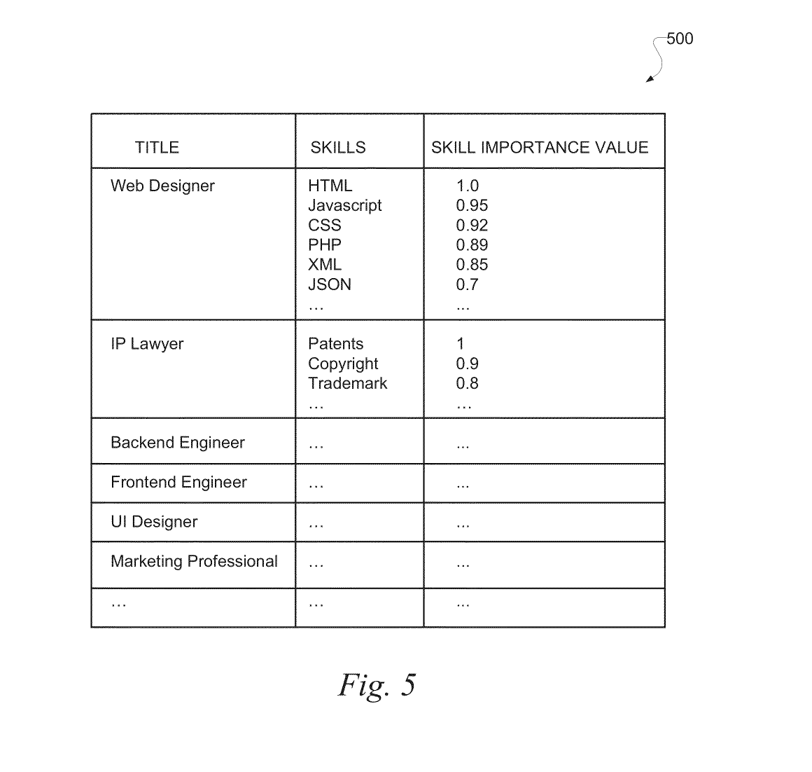

Referring back to the method 300 in FIG. 3, in operation 302, the skill mapping module 202 accesses skill mapping information identifying various sample skills associated with various sample job titles. For example, FIG. 5 illustrates exemplary skill mapping information 500 that identifies various job titles (e.g., “Web Designer”, “IP lawyer”, “backend engineer”, etc.) and, for each of the job titles, a list of skills associated with each of the job titles. In some embodiments, the skills identified in the skill mapping information 500 may be the most “important” skills for each of the job titles (e.g., skills that are expected or valued in individuals having the corresponding job). For example, the skill mapping information 500 indicates that the most important skills for the job title of Web Designer are HTML, JavaScript, CSS, and so on. The list of skills associated with each job title may be ranked based on an inferred importance of each of the specific skills for the job. For example, as illustrated in FIG. 5, the skill mapping information 500 includes skill importance values associated with each of the skills, where the skill importance values identify the importance of each of the skills. For example, for the job title of Web Designer, the most important skill is HTML, followed by CSS, and so on. The skill mapping information 500 may be stored locally at, for example, the database 206 illustrated in FIG. 2, or may be stored remotely at a database, data repository, storage server, etc., that is accessible by the team member recommendation system 200 via a network (e.g., the Internet). The manner in which the skill mapping information 500 and the ranked skill lists therein are generated is described in more detail below.

Referring back to the method 300 in FIG. 3, in operation 303, the skill mapping module 202 determines, based on the skill mapping information accessed in operation 302, a set of one or more specific skills associated with the specific job title that was specified in operation 301. For example, if the user selected the job title of “Web Designer” in the pull-down menu 402 in the user interface 400 (see FIG. 4), then the skill mapping module 202 will determine, based on the skill mapping information 500 in FIG. 5, that the skills of HTML, JavaScript, CSS, PHP, XML, JSON, etc., are associated with the job title of “Web Designer”.

Referring back to the method 300 in FIG. 3, in operation 304, the candidate identification module 204 identifies candidate team members of the team or project, from among members of a social network service having one or more of the specific skills that were identified in operation 303. The candidate identification module 204 may identify the candidate team members, based on member profile data associated with the members of a social network service. The social network service may correspond to social network system 20 illustrated in FIG. 1.

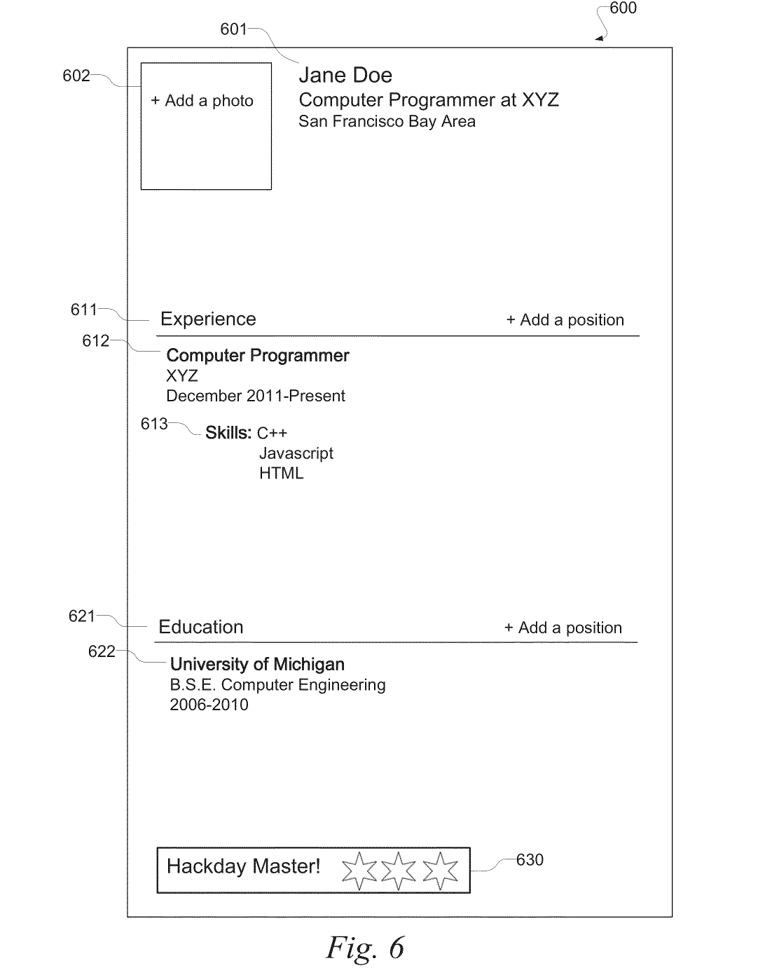

For example, social network services such as LinkedIn® or Facebook® may have multiple users or members, where each member of the networking website is able to upload an editable member profile page to the networking website (such as, for example, a LinkedIn® profile of the LinkedIn.com networking website). The member profile page may include various member profile data about the member, such as the member's biographical information, photographs of the member, and information describing the member's employment history, education history, skills, experience, activities, and the like. Such member profile pages of the networking website are then viewable by, for example, other members of the networking website. An example of a member profile page 600 of a member (e.g., a LinkedIn® page of a member “Jane Doe”) is illustrated in FIG. 6. As seen in FIG. 6, the member profile page 600 includes identification information 601, such as the member's name (“Jane Doe”), the member's current employment position, (“Computer Programmer at XYZ”), and geographic address/location information (“San Francisco Bay Area”). The member profile page also includes a photo area 602 for displaying a photograph of the member. Further, the member profile page includes various sections (also known as fields). For example, member profile page 600 includes an experience section 611 including listings of experience positions (e.g., employment/volunteer experience position 612) of the member, and an education section 621 including listings of educational credentials of the user (e.g., university degree or diploma 622 earned or currently being earned by the member). Further, the experience section 611 may also identify various skills 613 associated with the member, such as C++, Java script, HTML, etc.

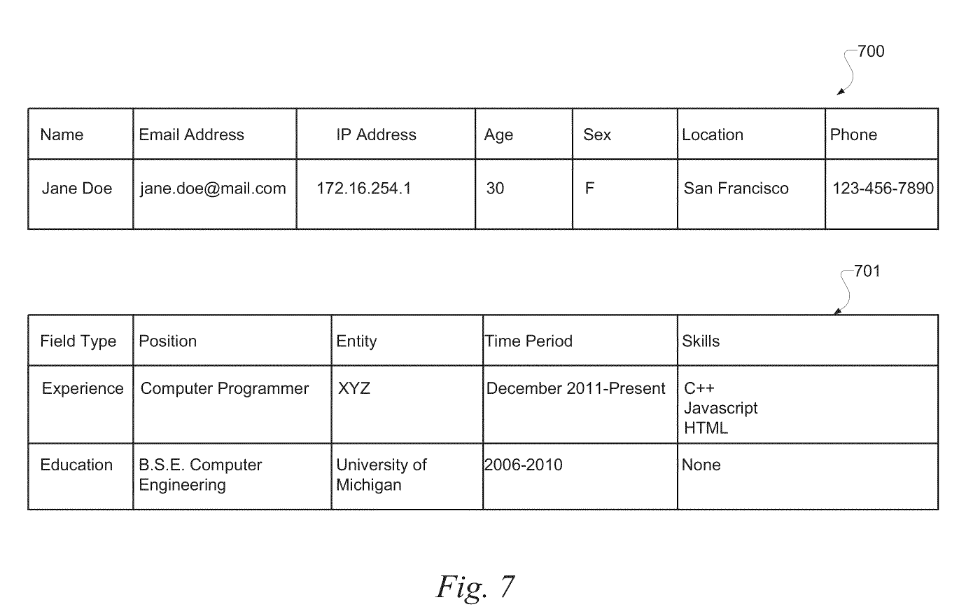

Thus, a social network service such as LinkedIn® or Facebook® may maintain various member profile data about each member, where at least a portion of the member profile data may be displayed in a member profile page associated with each member. Member profile data may also include information not displayed in a member profile page of the member, such as information received by the member during sign-up for an account on the social network service (e.g., IP address, birthdate, age, gender, financial account information, etc.). An example of member profile data 700 and 701 for the user Jane Doe is included in the FIG. 7, where the member profile data 700 and 701 includes some of the information in the member profile page 600 (see FIG. 6). The member profile data 700 and 701 may be included in, for example, database 28 or 30 in FIG. 1. The member profile page 600 and is merely exemplary, and while the member profile page 600 includes certain sections (e.g., experience sections and educations sections), it is apparent that these sections or fields may be supplemented or replaced by other sections or fields (e.g., a general portfolio section/field, an art portfolio section/field, a music portfolio section/field, a photography portfolio section/field, a multimedia section/field, and so forth). Those skilled in the art will understand that a member profile page may include other information, such as various identification information (name, username, email address, geographic address, networks, location, phone number, etc.), education information, employment information, resume information, skills, experience, activities, group membership, images, photos, preferences, news, status, links or URLs on the profile page, and so forth.

Thus, referring back to the method operation 304 in FIG. 3, the candidate identification module 204 may access member profile data for all the members (e.g., a member base) of a social network service, in order to find members associated with member profile data that correlates to the skills identified in operation 303. In other words, if the user specified the job title of “Web Designer” in operation 301, and if the skill mapping module 202 determined in operation 303 that the skills associated with this job title are HTML, JavaScript, CSS, etc., then the candidate identification module 204 may detect members that have these aforementioned skills. For example, the member profile data 701 in FIG. 7 describes the skills associated with the member “Jane Doe” including JavaScript and HTML, which correlate to the skills of a “Web Designer” (see FIG. 5). Thus, the user “Jane Doe” may be identified as a candidate team member for the job title of “Web Designer”.

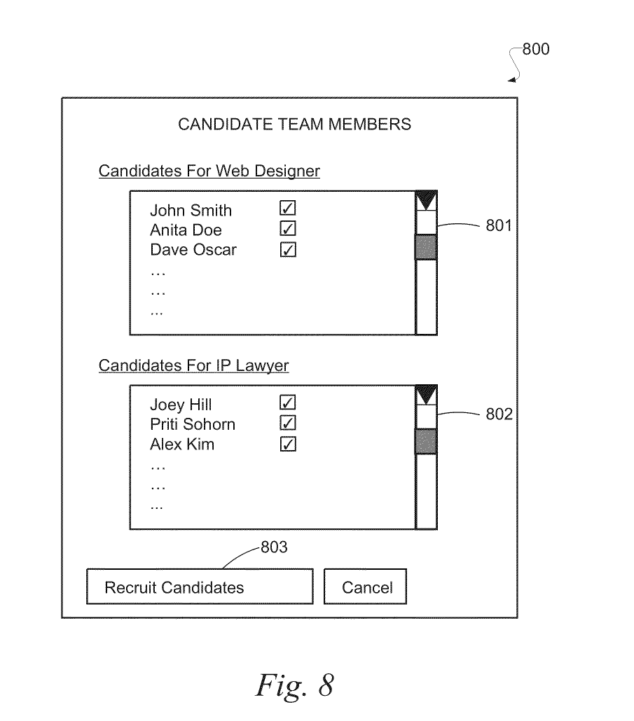

The candidate identification module 204 may display the candidate team members in a user interface. FIG. 8 illustrates an exemplary user interface 800 displayed by the candidate identification module 204, were the user interface displays candidate team members discovered by the candidate identification module 204 for each job title that was specified by the user via the user interface 400 illustrated in FIG. 4. For example, the user interface 800 includes candidates for job title of “Web Designer” 801, as well as candidates for the job title of “IP lawyer” 802, and so on. When the user selects the “recruit candidates” user interface element 803 (e.g., a button), the team member recommendation system 200 will proceed to automatically communicate with the candidates, as described in more detail in various embodiments below. The pull-down menus 801 and 802 that display the various candidates enable a user to deselect any of the candidates that are not desired to be recruited.

In some embodiments, the candidate team members discovered by the candidate identification module 204 may themselves have the exact job title (e.g., “Web Designer”) that was specified by the user via the user interface 400 in FIG. 4. However, it is possible that the candidate team members may have a different job title. For example, the user Jane Doe has the job title of “computer programmer”, but may still be identified as a candidate team member for the job title of “Web Designer”, since Jane Doe has the skills associated with the job title of “Web Designer”. This may be advantageous because many members of a social networking service such as LinkedIn have ad hoc job titles that may not necessarily matchup with predefined job titles utilized in conjunction with the team member recommendation system 200.

In some embodiments, the predefined job titles included in the user interface 400 may be defined using different levels of granularity or specificity. For example, the pull-down menu 402 may include the job title of “designer”, where this may encompass various different types of designers, such as UI designers, Web Designers, product designers, front-end designers, backend designers, etc. In other words, the skill mapping information 500 may identify a collection of skills (associated with each of the aforementioned types of designers) in association with the single job title “designer”. On the other hand, it is possible that the pull-down menu 402 may include more specific job titles such as “UI designer”, “Web Designer”, “product designer”, and so on. The choice of predefined job titles may be specified by an operator of the team member recommendation system 200, such as an administrator or IT personnel.

As described above, operation 304 in the method 300 of FIG. 3 includes discovering members of a social network service that possess one or more of the skills associated with a specified job title; such members may be referred to as “matching” members in the examples described herein. In various example embodiments, the number of matching skills required to be possessed by a member for that member to be considered as a matching member may be varied. For example, in some embodiments, the skills for each job title identified in the skill mapping information 500 (see FIG. 5) may have a corresponding importance value, such that the skills may be ranked based on importance. This information may be utilized in order to identify matching members. For example, in one embodiment, the matching members may be identified by searching for all members that have the most important skill for the given job title. In other embodiments, the matching members may be identified by searching for members that have at least the top X most important skills for a given job title (where X is, for example, an integer). In other embodiments, the matching members may be identified by searching for members that have the entire set of skills associated with the given job title. In other embodiments, the matching members may be identified by searching for members that have at least a minimum number of skills (notwithstanding skill importance) from the set of skills associated with the given job title. Accordingly, the number of matching members can be adjusted by the candidate identification module 204, by varying the number of skills used in the search for the matching members. In other words, if only the most important skill for a given job title is used to search for matching members, then it may be possible that there are too many matching members because too many members have the most important skill. Accordingly, the candidate identification module 204 may adjust the criteria for matching members to have at least the top X most important skills or all the skills associated with the given job title, in order to reduce the number of matching members to below a predetermined threshold. The team member recommendation system 200 may display a user interface allowing the user (e.g., an administrator or IT personnel) to adjust any of the aforementioned criterion or thresholds.

In some embodiments, once the candidate identification module 204 identifies the matching members, all of the matching members may be classified as candidate team members. However, this may result in a very large number of candidate team members. Accordingly, in various embodiments, only a subset of the matching members are classified as candidate team members. For example, according to various embodiments described below, once the candidate identification module 204 identifies the matching members, the candidate identification module 204 may then rank the matching members based on various criteria. Thereafter, the top X (where X is, for example, an integer) of the ranked matching members may be identified by the candidate identification module 204 as the candidate team members. Examples of criteria used for ranking matching members will now be described in more detail.

In some embodiments, the candidate identification module 204 may rank the matching members (having one or more of the specific skills associated with a given job title) based on a number of wins earned by each member in team project competitions. For example, various organizations that employ members often hold various types of competitions. For example, an engineering or technology-oriented company may hold a computer “hackday” or “hackathon” where teams of members participate together in order to complete a project. Prizes may be awarded to some of the teams based on their success. Accordingly, in some embodiments, the member profile data of various members may include historical information indicating how many “wins” each member has, where a win may be a prize or successful outcome in a competition. Thus, in some embodiments, the greater the number of wins for a member, the higher the ranking assigned to the member by the candidate identification module.

In some embodiments, the candidate identification module 204 may rank the matching members (having one or more of the specific skills associated with a given job title), based on a number of skills associated with each of the matching members. In some embodiments, the greater the number of skills for a member, the higher the ranking assigned to the member. In some embodiments, the lower the number of skills for a member, the higher the ranking assigned to the member. In some embodiments, the candidate identification module 204 may rank the members based on the total number of skills included in their member profile data. In some embodiments, the candidate identification module 204 may rank the members based on the number of skills matching the specific set of skills for a given job title (see skill mapping information 500 in FIG. 5). Various combinations of the above embodiments are possible. For example, in an embodiment, the greater the number of skills that a member has from the specific set of skills for a given job title, and the lower the number of skills that the member has from outside the specific set of skills for the given job title, the higher the ranking assigned to the member by the candidate identification module 204. This may be beneficial for determining how specialized a particular member is (e.g., if a member has too many non-relevant skills, it may indicate that the member is not specialized with regards to the relevant skills for a particular job).

In some embodiments, the candidate identification module 204 may rank the matching members (having one or more of the specific skills associated with a given job title) based on an ordering of skills in skill lists associated with the matching members. For example, each member of the social network service may have the ability to edit their member profile (and associated member profile data) by adjusting the order in which skills are listed. For example, with reference to the member profile page 600 illustrated in FIG. 6 (and associated member profile data 701 illustrated in FIG. 7), the skills for the member Jane Doe are presented in a specific order: C++, Java script, HTML. It is possible that the order in which skills are presented indicates the member's proficiency level in each of these skills and/or the member's estimation of their proficiency in each of these skills. For example, the member Jane Doe may believe that she is more proficient in C++ than JavaScript, and more proficient in JavaScript and HTML. Accordingly, in some embodiments, if the ordering of skills in the member profile data for a given member correlates more closely with the ranking of skills in the skill mapping information (see FIG. 5), then the ranking assigned to this member by the candidate identification module 204 may be increased. In other words, if the first listed skill for a first member matches the most important skill in the skill mapping information for a given job, this member may be given a higher ranking than a second member whose first listed skill only matches the third most important skill in the skill mapping information for the given job.

In some embodiments, the candidate identification module 204 may rank the matching members (having one or more of the specific skills associated with a given job title) based on a number of skill endorsements received by each of the matching members for the specific skills. For example, the social network services such as LinkedIn® allow members to receive endorsements for their skills, were the endorsements are similar to positive feedback or confidence votes. For example, although not illustrated in the member profile page 600 of FIG. 6, it is possible that the member Jane Doe may have 10 endorsements for the skill of C++, 5 endorsements for the skill of JavaScript, and 3 endorsements for the skill of HTML. Accordingly, in some embodiments, the candidate identification module 204 may finalize the distribution of endorsements for a given member, and if the distribution correlates more closely with the ranking of skills in the skill mapping information (see FIG. 5), then the ranking assigned to the member by the candidate identification module 204 may be increased. In other words, if the most endorsed skill for a first member matches the most important skill in the skill mapping information for a given job, this member may be given a higher ranking than a second member whose most endorsed skill only matches the third most important skill in the skill mapping information for the given job. In some embodiments, the candidate identification module 204 may check whether the number of endorsements given to each member satisfies one or more thresholds. (For example, a first higher threshold may be provided for the most important skill in the skill mapping information for a given job, a second lower threshold may be provided for the second most important skill in the skill mapping information for a given job, and so on.) In some embodiments, the candidate identification module 204 may compare various members by directly comparing the number of endorsements received by each member. For example, in some embodiments, the candidate identification module 204 may rank the members based on how many endorsements each member has received for the most important skill in the skill mapping information for a given job. In some embodiments, weights could be assigned to each skill in the skill mapping information for a given job title, based on the importance of that skill in the skill mapping information. In other words, the most important skill in the skill mapping information for a given job may be given a first higher weight, and the second most important skill in skill mapping information for a given job may be given a second lower weight, and so on. Thereafter, the candidate identification module 204 may access the number of endorsements that a particular user has for each skill, and multiply this number of endorsements by the corresponding weight value for that skill, to generate an endorsement total for each member. The endorsement totals for various members may then be compared, and the member having the highest endorsement total may be given the highest ranking, the member with the second highest endorsement total may be given the second-highest ranking, and so on.

In some embodiments, the candidate identification module 204 may rank the matching members (having one or more of the specific skills associated with a given job title) based on a degree of a connection on a social graph between the matching members and other team members associated with the team or project. For example, if a first matching member is a first-degree connection with one or more team members, and a second matching member is a second-degree connection with the one or more team members, then the ranking assigned to the first member by the candidate identification module 204 may be higher than the ranking assigned to the second member.

In some embodiments, the candidate identification module 204 may rank the matching members (having one or more of the specific skills associated with a given job title) based on a degree of a connection on a social graph between some of the matching members and other ones of the matching members. For example, if first matching member and a second matching member are first-degree connections with each other, whereas a third matching member and a fourth matching member are not first-degree connections with any of the other matching members, then the rankings assigned to the first and second matching members by the candidate identification module 204 may be higher than the rankings assigned to the third and the fourth matching members.

In some embodiments, the candidate identification module 204 may rank the matching members (having one or more of the specific skills associated with a given job title) based on collaboration history information indicating that the matching members have previously collaborated successfully with other team members associated with the team or project. For example, the aforementioned collaboration history information may be included in the member profile data for each member, and may indicate various collaborative team projects that each member has worked on (e.g., projects, conferences, presentations, work product, articles, publications, patents, etc.). Thus, if the collaboration history information indicates that a first matching member has collaborated successfully with one or more team members, and a second matching member has not collaborated successfully with the one or more team members, then the ranking assigned to the first member by the candidate identification module 204 may be higher than the ranking assigned to the second member.

In some embodiments, the candidate identification module 204 may rank the matching members (having one or more of the specific skills associated with a given job title) based on collaboration history information indicating that some of the matching members have previously collaborated successfully with other ones of the matching members. For example, if the collaboration history information indicates that a first matching member and a second matching member have previously collaborated successfully with each other, whereas a third matching member and a fourth matching member have not previously collaborated successfully with any of the other matching members, then the rankings assigned to the first and second matching members by the candidate identification module 204 may be higher than the rankings assigned to the third and the fourth matching members.

In some embodiments, the candidate identification module 204 may rank the matching members (having one or more of the specific skills associated with a given job title) based on any other type of attribute included in the member profile data of the matching members, including attributes such as education, location, company department, and so on. For example, the ranking assigned to a matching member may be increased if the members has the same alma mater as other team members or matching members, or if the member is at the same location as other team members or matching members, or if the member is at the same company department as other team members or matching members, and so on.

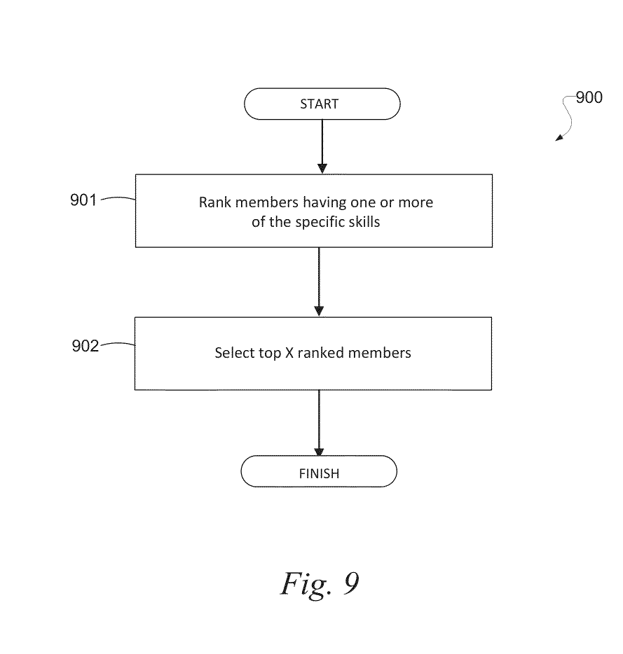

FIG. 9 is a flowchart illustrating an example method 900, consistent with various embodiments described above. The method 900 may be performed at least in part by, for example, the team member recommendation system 200 illustrated in FIG. 2 (or an apparatus having similar modules, such as client machines or application servers). The method 900 may replace operation 304 in the method 300 in FIG. 3. In operation 901, the candidate identification module 204 ranks matching members (e.g., members having one or more of the specific skills identified in operation 304) based on various criteria described in the examples above. In operation 902, the candidate identification module 204 may select the top X ranked members, and identify these selected members as the candidate team members for the team or project.

Various techniques for the generation of the skill mapping information (see FIG. 5) by the skill mapping module 202 will now be described. As described above, the skills identified in the skill mapping information 500 may be the most “important” skills for each of the job titles (e.g., skills that are expected or valued in individuals having the corresponding job described by the job title). In some embodiments, the skill mapping module 202 may generate the skill mapping information for a given job title (e.g., Web Designer) by accessing member profile data associated with all members of a social network service having that job title, and by detecting the skills in the member profile data of these members. For example, if the skill mapping module 202 detects a particular skill in the member profile data of all or a statistically significant portion (e.g., majority) of members associated with a given job title, then the skill mapping module 202 may include this skill as an “important” skill in the skill mapping information for the given job title. The candidate identification module 204 may also take into account the uniqueness of the skill with respect to other job titles (e.g., if skills such as “communication skills” or “interpersonal skills” are present in most member profiles of web developers and non-web developers of the social network service, then these skills are perhaps not the most important skills for a web developer.

In some embodiments, the skill mapping module 202 may identify skills associated with a given job title by crawling webpages accessible via a network (e.g., the Internet) for information associated with that job title. For example, job advertisements for a specific job title (e.g., Web Designer) will generally include a list of requirements for candidates, were these requirements may serve as a proxy for the skills described throughout. Accordingly, the skill mapping module 202 may crawl job postings in order to identify skills associated with various job titles. The skill mapping module 202 may also crawl other types of information, such as articles describing various job titles, articles describing a specific individual having the specific job title, and so on, where such information may identify various skills associated with various job titles.

As described above, the list of skills in the skill mapping information associated with each job title may be ranked, based on an inferred importance of each of the specific skills for that job title. For example, as illustrated in FIG. 5, the skill mapping information 500 includes skill importance values associated with each of the skills, where the skill importance values identify the importance of each of the skills.

In some embodiments, the inferred importance of each of the skills may be determined based on an occurrence count of the skill in the member profile data of members having a job title. For example, the most highly represented skill in the member profile data of members having a given job title may be assigned a higher ranking, in comparison to the second most highly represented skill.

In some embodiments, the inferred importance of each of the skills may be determined based on an average position of the skill in skill lists of the member profile data of members having a job title. For example, if a particular skill of “HTML” tends to be the first listed skill for most members having a given job title, then this may indicate that this is an important skill for that job title. Accordingly, the skill that is listed first on average for users having a given job title may be given a higher ranking, in comparison to the skill that is listed second on average, and so on.

In some embodiments, the inferred importance of each of the skills may be determined based on an average endorsement count of the skill in the member profile data of members having a job title. For example, if a particular skill of “HTML” tends to be the most endorsed skill for most members having a given job title, then this may indicate that this is an important skill for that job title. Accordingly, the skill that is most endorsed on average for users having a given job title may be given a higher ranking, in comparison to the second most endorsed skill on average, etc.

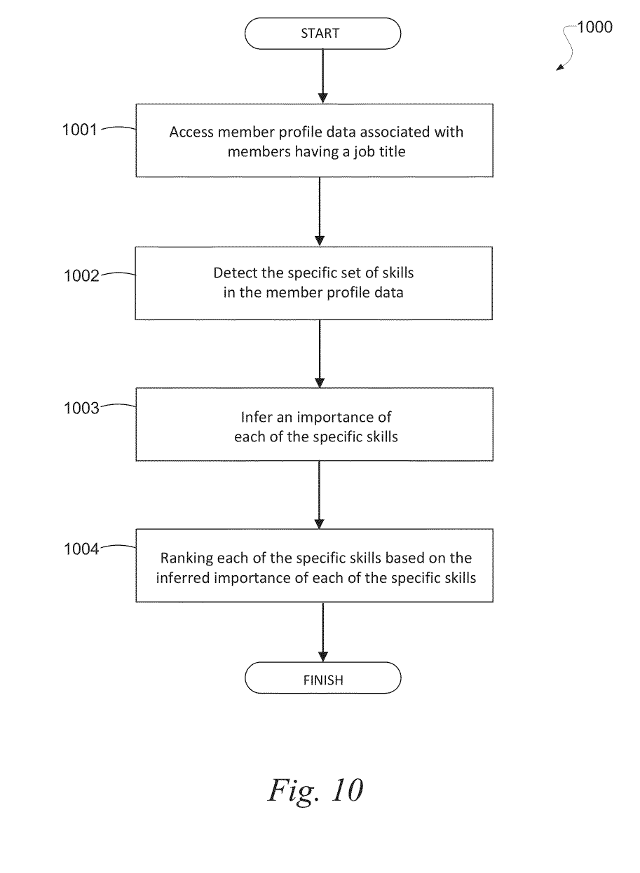

FIG. 10 is a flowchart illustrating an example method 1000 for generating skill mapping information, consistent with various embodiments described above. The method 1000 may be performed at least in part by, for example, the team member recommendation system 200 illustrated in FIG. 2 (or an apparatus having similar modules, such as client machines or application servers). In operation 1001, the skill mapping module 202 accesses member profile data associated with members having a given job title (e.g., “Web Designer”). In operation 1002, the skill mapping module 202 detects a specific set of skills in all or at least a portion of the member profile data accessed in operation 1001. In operation 1003, the skill mapping module 202 infers an importance of each skill in the specific set of skills detected in operation 1002. In operation 1004, the skill mapping module 202 ranks each of the specific skills, based on the inferred importance of each of the skills.

Referring back to FIG. 8, the user interface 800 displays various lists of candidate team members for different job titles. If the user selects on any one of the displayed names, the user may be presented with the member profile page of that selected member, whereby the user may initiate communication with that selected member. According to various exemplary embodiments, the user may also select the “Recruit Candidates” button 803 to cause the team member recommendation system 200 automatically recruit these candidates.

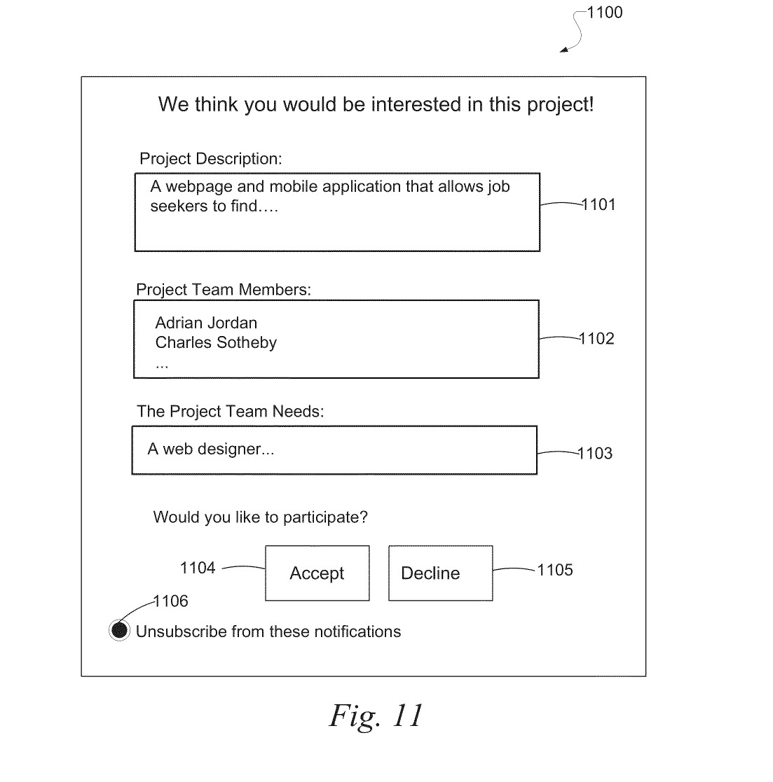

For example, in some embodiments, after the user selects the “Recruit Candidates” button 803, the notification module 208 may transmit a notification to each of the (selected) candidate team members in the user interface 800. Each notification may include team description information describing the team or project description information describing the project, and an invitation to participate in the team or project. For example, FIG. 11 illustrates an exemplary notification message 1100 that includes project description information 1101 describing a project, team member information 1102 describing team members, and team requirement information 1103 describing one or more of the job titles of candidates desired for the team or project. The user interface 1100 also invites the recipient to participate in the team or project. When the recipient selects the “Accept” button 1104, the notification module 208 receives the affirmative response from the recipient, and designates the corresponding candidate team member as a team member. The unsubscribe option 1106 permits the candidate to decline future invitations. In some embodiments, the notification module 208 may add the corresponding candidate team member to a social network group associated with the team or project (e.g., a social network group hosted by a social network service such as LinkedIn®, Jive®, Yammer®, and so on). In some embodiments, the notification may be included in an email message, a text message (e.g., a short message service or SMS message, a multimedia messaging service or MMS message, etc.), or an instant message transmitted to the corresponding candidate team member. In some embodiments, the notification may be included in a content feed or news feed of the corresponding candidate team member.

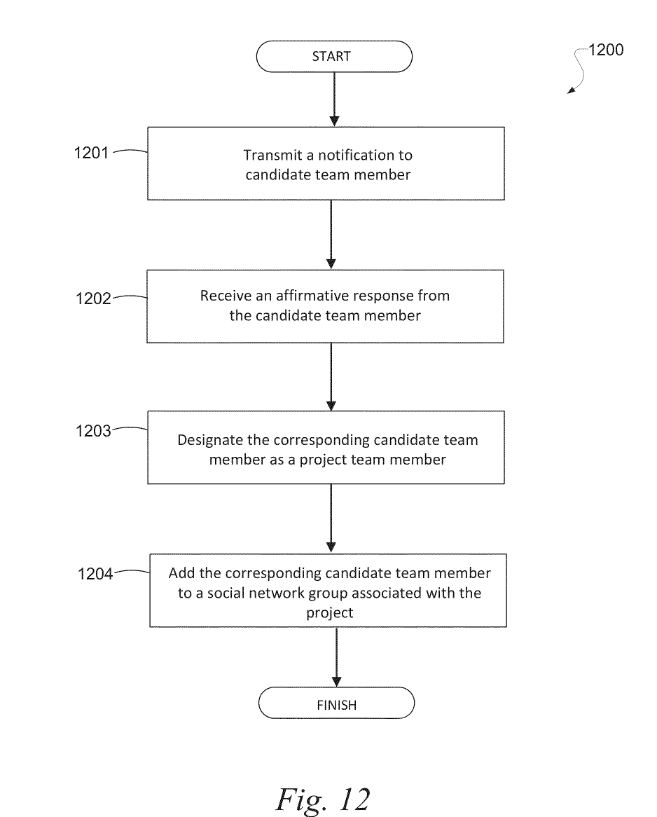

FIG. 12 is a flowchart illustrating an example method 1200, consistent with various embodiments described above. The method 1200 may be performed at least in part by, for example, the team member recommendation system 200 illustrated in FIG. 2 (or an apparatus having similar modules, such as client machines or application servers). The method 1200 may occur after the method 300 illustrated in FIG. 3. In operation 1201, the notification module 208 transmits a notification to a candidate team member, the notification including team information describing a team, or project description information describing a project, as well as an invitation to participate in the team or project. An example of such a notification is illustrated in FIG. 11. In operation 1202, the notification module 208 receives, in response to the invitation to participate, an affirmative response from the corresponding candidate team member. In operation 1203, the candidate identification module 204 designates the corresponding candidate team member as a team member of the team or project. In operation 1204, the candidate identification module 204 adds the corresponding candidate team member to a social network group associated with the team or project.

According to various exemplary embodiments, when a candidate team member selects on the “Accept” button 1104 in FIG. 11, the notification module 208 may query the candidate team member for further feedback information as to why they accepted the invitation. For example, the notification module 208 transmits a message with questions and/or a survey to the corresponding candidate team member, and receives the appropriate responses with feedback information. This feedback information may then be fed into a feedback loop based on machine learning techniques utilized by the team member recommendation system 200 to improve future suggestions for candidate team members. For example, if a particular user indicates that they accepted an invitation to work on a team or project because they liked the team leader, or they liked the idea of the project, or they liked the technology associated with the project, etc., then this information may be stored and utilized by the team member recommendation system 200 for machine learning. Thereafter, the next time a team or project has a similar team leader, or similar idea, or similar technology, etc., the candidate identification module 204 may be more likely to recommend the particular user as a candidate team member (and more likely to communicate an invitation to the particular user). In some embodiments, the candidate identification module 204 may also utilize this feedback information to recommend other users similar to the particular user as candidate team members. User similarity may be determined based on, for example, similar member profile data.

On the other hand, when a candidate key member selects on the “Decline” button 1105 in FIG. 11, the notification module 208 may query the candidate team member for further feedback information as to why they did not accept the invitation. If a particular user indicates that they did not accept an invitation to work on a team or project because they did not like the team leader, or they did not like the idea of the project, or they did not like the technology associated with the project, etc., then this information may be stored and utilized by the team member recommendation system 200 for machine learning. Thereafter, the next time a team or project has a similar team leader, or similar idea, or similar technology, etc., the candidate identification module 204 may be less likely to recommend the particular user as a candidate team member (and less likely to communicate an invitation to the particular user). In some embodiments, the candidate identification module 204 may also utilize this feedback information to prevent recommending other users similar to the particular user as candidate team members. User similarity may be determined based on, for example, similar member profile data.

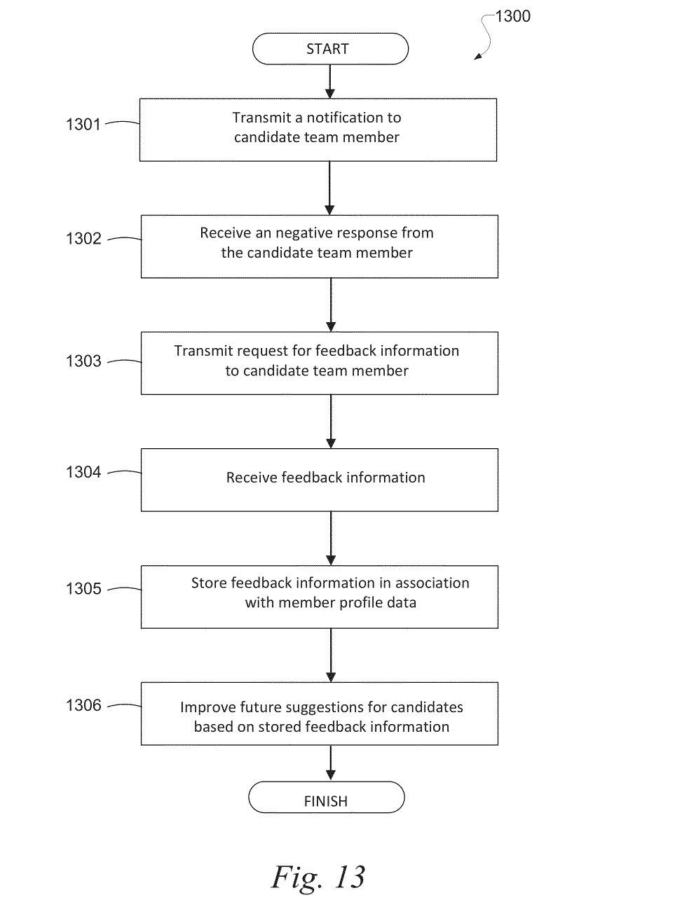

FIG. 13 is a flowchart illustrating an example method 1300, consistent with various embodiments described above. The method 1300 may be performed at least in part by, for example, the team member recommendation system 200 illustrated in FIG. 2 (or an apparatus having similar modules, such as client machines or application servers). The method 1300 may occur after the method 300 illustrated in FIG. 3. In operation 1301, the notification module 208 transmits a notification to a candidate team member, the notification including team information describing a team, or project description information describing a project, as well as an invitation to participate in the team or project. An example of such a notification is illustrated in FIG. 11. In operation 1302, the notification module 208 receives, in response to the invitation to participate, a negative response (e.g., decline) from the corresponding candidate team member. In operation 1303, the candidate identification module 204 transmits a request for feedback information (e.g., in the form of questions, a query, a survey, a questionnaire, etc.) to the candidate team member. In operation 1304, candidate identification module 204 receives a response including feedback information (e.g., in the form of answers to the questionnaire, a completed survey, etc.). In operation 1305, the candidate identification module 204 stores the feedback information within, or in association with, member profile data of the candidate team member. In operation 1306, the candidate identification module 204 utilizes the stored feedback information to improve a future suggestion for candidates for a team or project. For example, the candidate identification module 204 may be less likely to recommend a particular user as a candidate team member for a team or project similar to a team or project that the user previously declined to join, based on the feedback information associated with a user. Accordingly, feedback information may be fed into a feedback loop based on machine learning techniques utilized by the team member recommendation system 200 to improve future suggestions for candidate team members.

Referring back to FIG. 6, the member profile page 600 may also include badge information 630 identifying various badges, awards, certifications, prizes, titles, status levels, etc. that the user may have received in conjunction with participating in a team or team project. For example, when a member interacts with others on a team to successfully complete a project, the team member recommendation system 200 may update the badge information 630 to reflect badges, awards, certifications, prizes, titles, status levels, etc., that were awarded to the member. Alternatively, the team member recommendation system 200 may itself assign badges, awards, certifications, prizes, titles, status levels, etc., which may be reflected in the badge information 630. Accordingly, the member may be recognized and awarded for their teamwork and their contributions to successfully completing a team project. The team member recommendation system 200 may determine that a project has been successfully completed based on member profile data associated with the project team members, or based on updates included in a social network group associated with the project (e.g., a social network group hosted by a social network service such as LinkedIn®, Jive®, Yammer®, and so on). In some embodiments, the badge information 630 may be displayed on a general member profile page (see FIG. 6). In other embodiments, the badge information 630 may be restricted to team member profile pages viewable within the context of a restricted social network associated with team-based projects.

According to various exemplary embodiments, the team member recommendation system 200 may take into account a bandwidth or workload of a member in order to improve suggestions for candidate team members for a team or project. For example, if a particular user is already engaged on one or more teams or projects, the candidate identification module 204 may be less likely to recommend this particular user for another team or project. The candidate identification module 204 may determine that a particular user is already engaged in one or more teams or projects based on, for example, member profile page or member profile data associated with the candidate, or information included in social network groups associated with teams or projects (e.g., social network groups hosted by a social network service such as LinkedIn®, Jive®, Yammer®, and so on). Moreover, if the candidate identification module 204 adds a candidate to a team or project (see operation 1203 in FIG. 12), the candidate identification module 204 may itself update a member profile of the member accordingly to indicate the membership or participation. For example, the candidate identification module 204 may update a general member profile page (see FIG. 6) of the member, or a team member profile page of the member viewable within the context of a restricted social network associated with team-based projects, or information included in social network groups associated with teams or projects (e.g., social network groups hosted by a social network service such as LinkedIn®, Jive®, Yammer®, and so on).

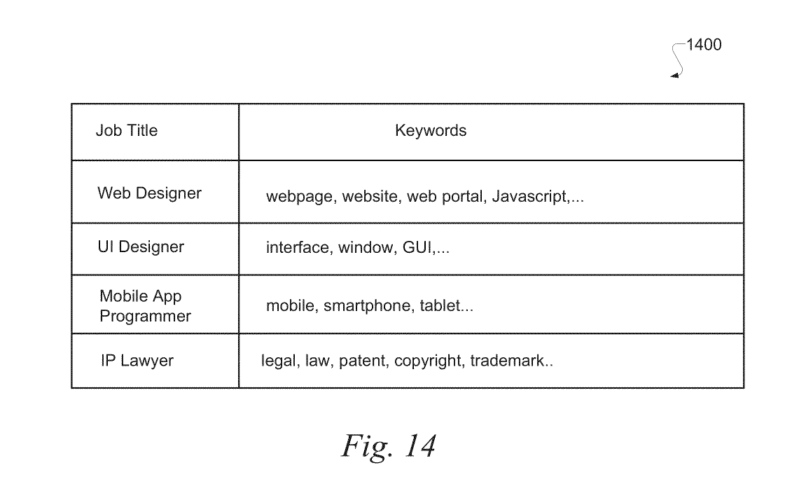

In various embodiments described above, a user may manually specify specific job titles (see FIG. 4). According to various exemplary embodiments, the skill mapping module 202 is configured to automatically infer job titles, based on team description information describing a team or the project description information describing the project (e.g., project description information 401 describing the project). For example, if the project description information 401 specifies that the project will involve generating a “mobile app”, then the skill mapping module 202 may infer that a Mobile Application Designer may be required for the project. Accordingly, in various example embodiments, the skill mapping module 202 may scan the team description information or project description information 401 for keywords associated with various job titles. For example, FIG. 14 illustrates exemplary job title keyword information 1400 that identifies various job titles (such as Web Designer, UI designer, etc.) and, for each of the job titles, a set of associated keywords. For example, for the job title of Web Designer, associated keywords include webpage, website, web portal, JavaScript, etc., whereas for the job title of Mobile App Programmer, the associated keywords include mobile, smartphone, tablet, etc. Thus, the skill mapping module 202 may access this job title keyword information 1400. If the skill mapping module 202 detects keywords associated with a specific job title in team description information or the project description information 401, the skill mapping module 202 may infer that candidate team members associated with this job title are desired for this team or project. Accordingly, the skill mapping module 202 may proceed to find candidate team members having this job title, as described in various embodiments above, and present these candidates team members to the user (e.g., see FIG. 8). The aforementioned job title keyword information 1400 may be stored locally at, for example, the database 206 illustrated in FIG. 2, or may be stored remotely at a database, data repository, storage server, etc., that is accessible by the team member recommendation system 200 via a network (e.g., the Internet).

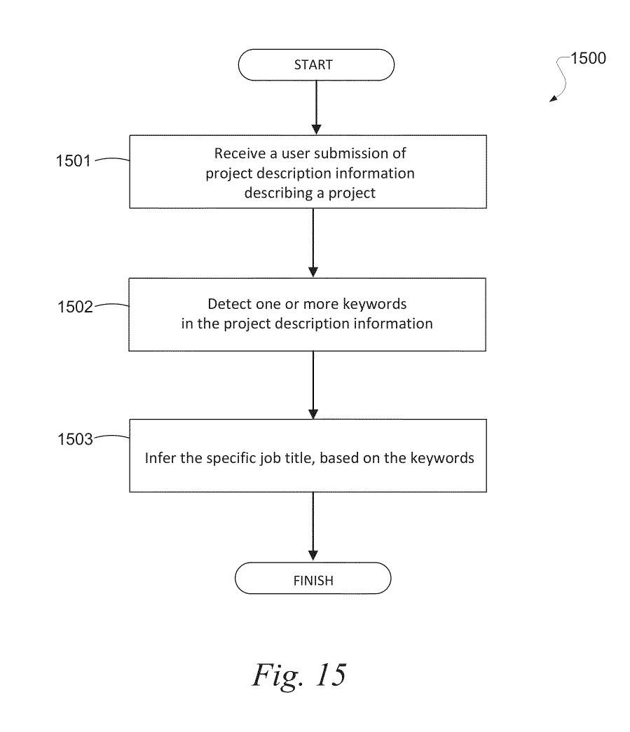

FIG. 15 is a flowchart illustrating an example method 1500, consistent with various embodiments described above. The method 1500 may be performed at least in part by, for example, the team member recommendation system 200 illustrated in FIG. 2 (or an apparatus having similar modules, such as client machines or application servers). The operation 1500 may replace operation 301 in the method 300 illustrated in FIG. 3. In operation 1501, the skill mapping module 202 receives a user submission of team description information describing a team or project description information describing a project. In operation 1502, the skill mapping module 202 detects one or more keywords in the team description information or project description information received in operation 1501. In operation 1503, the skill mapping module 202 infers a specific job title for a candidate team member for the team or project, based on the keywords detected in operation 1502.

### Example Mobile Device

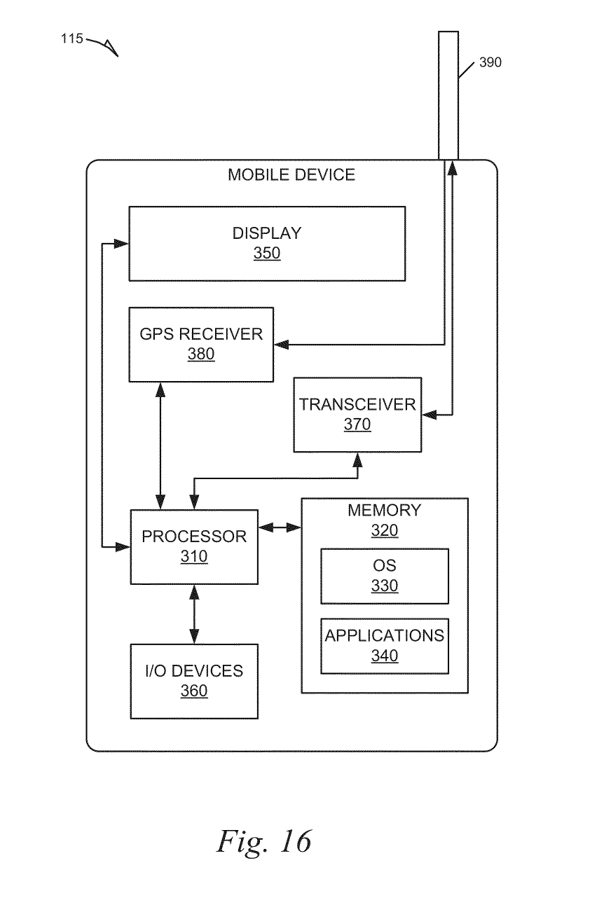

FIG. 16 is a block diagram illustrating the mobile device 115, according to an example embodiment. The mobile device 115 may include a processor 310. The processor 310 may be any of a variety of different types of commercially available processors suitable for mobile devices (for example, an XScale architecture microprocessor, a Microprocessor without Interlocked Pipeline Stages (MIPS) architecture processor, or another type of processor). A memory 320, such as a Random Access Memory (RAM), a Flash memory, or other type of memory, is typically accessible to the processor. The memory 320 may be adapted to store an operating system (OS) 330, as well as application programs 340, such as a mobile location enabled application that may provide LBSs to a user. The processor 310 may be coupled, either directly or via appropriate intermediary hardware, to a display 350 and to one or more input/output (I/O) devices 360, such as a keypad, a touch panel sensor, a microphone, and the like. Similarly, in some embodiments, the processor 310 may be coupled to a transceiver 370 that interfaces with an antenna 390. The transceiver 370 may be configured to both transmit and receive cellular network signals, wireless data signals, or other types of signals via the antenna 390, depending on the nature of the mobile device 115. Further, in some configurations, a GPS receiver 380 may also make use of the antenna 390 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

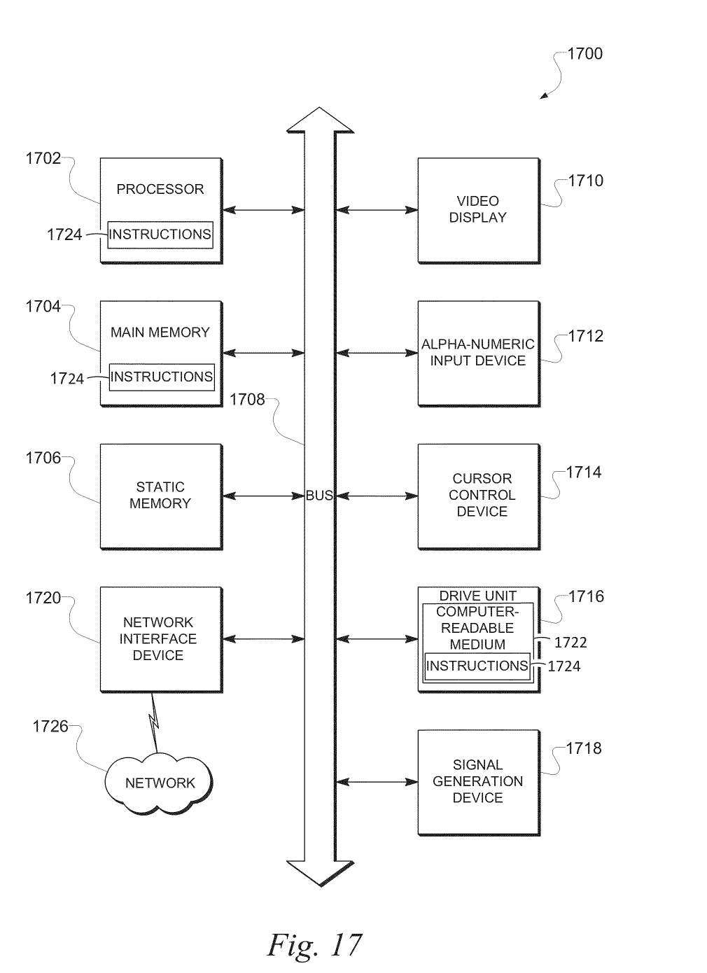

FIG. 17 is a block diagram of machine in the example form of a computer system 1700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU), a graphics processing unit (GPU) or both), a main memory 1704 and a static memory 1706, which communicate with each other via a bus 1708. The computer system 1700 may further include a video display unit 1710 (e.g., a liquid crystal display (LCD) or a cathode ray tube (CRT)). The computer system 1700 also includes an alphanumeric input device 1712 (e.g., a keyboard or a touch-sensitive display screen), a user interface (UI) navigation device 1714 (e.g., a mouse), a disk drive unit 1716, a signal generation device 1718 (e.g., a speaker) and a network interface device 1720.

### Machine-Readable Medium

The disk drive unit 1716 includes a machine-readable medium 1722 on which is stored one or more sets of instructions and data structures (e.g., software) 1724 embodying or utilized by any one or more of the methodologies or functions described herein. The instructions 1724 may also reside, completely or at least partially, within the main memory 1704 and/or within the processor 1702 during execution thereof by the computer system 1700, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A computer-implemented method comprising:
receiving a user request to identify one or more potential team members of a team, the user request including a user specification of a specific job title;
accessing member profile data associated with members of a social network service;
identifying a portion of the members of the social network service having the specific job title;
identifying specific skills included in member profile data associated with the portion of the members of the online social network service having the specific job title;
generating, using one or more processors, skill mapping information identifying various sample skills associated with various sample job titles, the skill mapping information identifying the specific skills as being associated with the specific job title;
determining, based on the skill mapping information, that the specific skills are associated with the specific job title; and
identifying candidate team members of the team from among members of the social network service having one or more of the specific skills, based on the member profile data associated with the candidate team members.

2. (canceled)

3. The method of claim 1, wherein the skill mapping information identifies the specific skills in a ranked list, the list being ranked based on an importance of each of the specific skills for the specific job title.

4. The method of claim 3, wherein the importance of each of the specific skills is automatically determined based on an occurrence count of the specific skill in the member profile data of members having the specific job title.

5. The method of claim 3, wherein the importance of each of the specific skills is automatically determined based on an average position of the specific skill in skill lists of the member profile data of members having the specific job title.

6. The method of claim 3, wherein the importance of each of the specific skills is automatically determined based on an average endorsement count of the specific skill in the member profile data of members having the specific job title.

7. The method of claim 1, wherein the identifying of the candidate team members further comprises:
ranking the members having one or more of the spec skills, based on a number of wins earned by each member in team competitions.

8. The method of claim 1, wherein the identifying of the candidate team members further comprises:
ranking the members having one or more of the specific skills, based on a number of skills associated with each member.

9. The method of claim 1, wherein the identifying of the candidate team members further comprises:
ranking the members having one or more of the specific skills, based on an ordering of skills in skill lists associated with the members.

10. The method of claim 1, wherein the identifying of the candidate team members further comprises:
ranking the members having one or more of the specific skills, based on a number of skill endorsements received by each member for the specific skills.

11. The method of claim 1, wherein the identifying of the candidate team members further comprises:
ranking the members having one or more of the specific skills, based on a degree of a connection on a social graph between the members and other team members associated with the team.

12. The method of claim 1, wherein the identifying of the candidate team members further comprises:
ranking the members having one or more of the specific skills, based on a degree of a connection on a social graph between some of the members and other ones of the members.

13. The method of claim 1, wherein the identifying of the candidate team members further comprises:
ranking the members having one or more of the specific skills, based on collaboration history information indicating that the members have previously collaborated successfully with other team members associated with the team.

14. The method of claim 1, wherein the identifying of the candidate team members further comprises:
ranking the members having one or more of the specific skills, based on collaboration history information indicating that some of the members have previously collaborated successfully with other ones of the members.

15. The method of claim 1, further comprising:
transmitting a notification to at least one of the candidate team members, the notification including team description information describing the team and an invitation to join the team.

16. The method of claim 15, wherein the notification is included in at least one of:
an email message, a text message, or an instant message transmitted to the corresponding candidate team member; and
a content feed of the corresponding candidate team member.

17. The method of claim 15, further comprising:
receiving, in response to the invitation to participate, an affirmative response from the corresponding candidate team member; and
designating the corresponding candidate team member as a team member, and adding the corresponding candidate team member to a social network group associated with the team.

18. The method of claim 1, further comprising:
receiving a user submission of project description information describing a project;
detecting one or more keywords in the project description information; and
inferring the specific job title, based on the keywords.

19. A system comprising:
a machine including a memory and at least one processor;
a skill mapping module, executable by the machine, configured to:
receive a user request to identify one or more potential team members of a team, the user request including a user specification of a specific job title;
access member profile data associated with members of a social network service;
identify a portion of the members of the social network service having the specific job title;
identify specific skills included in member profile data associated with the portion of the members of the online social network service having the specific job title,
generate skill mapping information identifying various sample skills associated with various sample job titles, the skill mapping information identifying the specific skills as being associated with the specific job title; and
determine, based on the skill mapping information, that the specific skills are associated with the specific job title; and
a candidate identification module configured to identify candidate team members of the team from among members of the social network service having one or more of the specific skills, based on the member profile data associated with the candidate team members.

20. A non-transitory machine-readable storage medium having embodied thereon instructions executable by one or more machines to perform operations comprising:
receiving a user request to identify one or more potential team members of a team, the user request including a user specification of a specific job title;
accessing member profile data associated with members of a social network service;
identifying a portion of the members of the social network service having the specific job title;
identifying specific skills included in member profile data associated with the portion of the members of the online social network service having the specific job title;
generating skill mapping information by identifying various sample skills associated with various sample job titles, the skill mapping information identifying the specific skills as being associated with the specific job title;
determining, based on the skill mapping information, that the specific skills are associated with the specific job title; and
identifying candidate team members of the team from among members of the social network service having one or more of the specific skills, based on the member profile data associated with the candidate team members.

21. The method of claim 1, further comprising:
determining the importance of the various sample skills associated with the various sample job titles using the member profile data of at least a portion of the members.
